(19) United States
(12) Patent Application Publication
(10) Pub. No.: US 2005/0018253 A1
(43) Pub. Date: Jan. 27, 2005

(54) Image pickup apparatus for correcting image deterioration due to fixed pattern noise, and image pickup method

(75) Inventor: Nobuhiro Takeda, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/892,168

(22) Filed: Jul. 16, 2004

(30) Foreign Application Priority Data
Jul. 22, 2003 (JP) 2003-277770

(51) Int. Cl. H04N 1/04

(52) U.S. Cl. 358/474

(57) ABSTRACT

In order to attain an image pickup technique in which a photographing time of a dark image which becomes the cause of a shutter release time lag or a waiting time for the photographing is reduced to the minimum, both of a dark noise component which depends on an accumulation time and a circuit system noise component which does not depend on the accumulation time can be corrected and a good image can be obtained, an image pickup apparatus includes an image pickup unit for obtaining image data by picking up a plurality of images of different charge accumulation time in a non-exposing state and obtaining image data by picking up images in an exposing state and a correcting unit for correcting the image data of the images picked up in the exposing state on the basis of the image data of the plurality of images picked up in the non-exposing state, wherein the charge accumulation time for the image data of the plurality of images picked up in the non-exposing state is shorter than that of the image data of the images picked up in the exposing state.

This application claims priority from Japanese Patent Application No. 2003-277770 filed Jul. 22, 2003, which is hereby incorporated by reference herein.

### BACKGROUND OF THE INVENTION

1. Field of the Invention

The invention relates to an image pickup technique, more particularly, to a technique for correcting photographed image data.

2. Related Background Art

Hitherto, as such a kind of image pickup apparatus, a photographing apparatus such as an electronic camera or the like in which a memory card having a solid state memory device is used as a recording medium, thereby recording and reproducing an object image picked up by a solid state image pickup element such as CCD, CMOS, or the like has been put into the market.

In the case of image pickup by using the solid state image pickup element such as CCD, CMOS, or the like, an arithmetic operation processing may be executed on dark image data read out after charge accumulation is performed in a manner similar to the main photographing in the state where the image pickup element is not exposed and main photographed image data read out after the charge accumulation is performed in the state where the image pickup element is exposed, so that a dark noise correction processing can be executed.

Thus, the object image of high quality can be obtained by correcting the photographed image data against deterioration in picture quality due to dark noise components depending on a charge accumulation time due to dark current noises which are generated in the image pickup element or pixel defects which are peculiar to the image pickup element.

Since those dark noise components increase depending on the elapse of the charge accumulation time and in accordance with an increase in temperature of the image pickup element, the dark noise correcting process is a useful function for the user of the electronic camera to obtain a large picture quality improving effect when an exposure is executed for a long seconds of time or at a high temperature.

Japanese Patent Application Laid-open No. 2000-201294 has also been disclosed.

However, in the conventional image pickup apparatus such as an electronic camera or the like as mentioned above, in the dark noise correcting process, dark image data of the same accumulation time as that of the photographing of the main photographed image data is necessary. For example, in the case of executing the main photographing after the dark image is photographed, a shutter release time lag increases by a dark image photographing time, so that there is a risk of missing a precious shutter chance. There is also such a problem that in the case of photographing the dark image after the execution of the main photographing, a photographing interval to the next photographing increases by the dark image photographing time and the photographing interval in the case of continuously photographing becomes long.

Further, nothing is considered about photographing conditions and environmental conditions other than in the case of the exposure of a long seconds of time or one at a high temperature. That is, although noises of a circuit system exist besides the deterioration in picture quality due to the dark current noises which are generated in the image pickup element or the pixel defects which are peculiar to the image pickup element, nothing is considered about such circuit system noises. The circuit system noises are fixed pattern noises as a dark offset which are generated in the image pickup element due to voltage unevenness caused by a resistance component of a power source line, circuit element variation, or the like. Those circuit system noises are generated regardless of the charge accumulation time.

### SUMMARY OF THE INVENTION

It is an object of the invention to provide a photographing technique in which while a photographing time of a dark image which becomes a cause of a shutter release time lag or a waiting time for photographing is reduced to the minimum, both of a dark noise component which depends on an accumulation time and a circuit system noise component which does not depend on the accumulation time can be corrected and a good image can be obtained.

Since the charge accumulation time for the photographing in a non-exposing state can be set to be shorter than that in the case of an exposing state, the shutter release time lag can be reduced and such a problem that the photographer misses a shutter chance due to the shutter release time lag is eliminated. While a photographing time in the non-exposing state which becomes the cause of the shutter release time lag or the waiting time for photographing is reduced to the minimum, image data of an image photographed in the exposing state is corrected on the basis of image data of a plurality of images photographed in the non-exposing state and a deterioration in picture quality can be prevented.

According to an aspect of the invention, an image pickup apparatus of the present invention comprises: an image pickup unit for obtaining image data by picking up a plurality of images of different charge accumulation time in a non-exposing state and obtaining image data by picking up images in an exposing state; and a correcting unit for correcting the image data of the images picked up in the exposing state on the basis of the image data of the plurality of images picked up in the non-exposing state, wherein the charge accumulation time for the image data of the plurality-of images picked up in the non-exposing state is shorter than that of the image data of the images photographed in the exposing state.

According to another aspect of the invention, an image pickup method of the present invention comprises: an image pickup step of obtaining image data by picking up a plurality of images of different charge accumulation time in a non-exposing state and obtaining image data by picking up images in an exposing state; and a correcting step of correcting the image data of the images photographed in the exposing state on the basis of the image data of the plurality of images picked up in the non-exposing state, wherein the charge accumulation time for the image data of the plurality of images picked up in the non-exposing state is shorter than that of the image data of the images picked up in the exposing state.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a construction of an electronic camera in an embodiment of the invention;

FIG. 2 is a flowchart showing a photographing operation processing procedure of an image processing apparatus 100;

FIG. 3 is a flowchart showing the photographing operation processing procedure of the image processing apparatus 100 and is the sequel to FIG. 2;

FIG. 4 is a flowchart showing the photographing operation processing procedure of the image processing apparatus 100 and is the sequel to FIGS. 2 and 3;

FIG. 5 is a flowchart showing a distance measurement/photometry processing procedure in step S114;

FIG. 6 is a flowchart showing a photographing processing procedure in step S127;

FIG. 7 is a flowchart showing the photographing processing procedure in step S127 and is the sequel to FIG. 6;

FIG. 8 is a flowchart showing a dark pickup processing procedure in steps S121 and S130; and

FIG. 9 is a flowchart showing a dark correction processing procedure in step S131.

### DETAILED DESCRIPTION OF THE PREFERRED EMBODIMENTS

Preferred embodiments of the present invention will now be described in detail in accordance with the accompanying drawings.

An image pickup apparatus, an image pickup method, a program, and a storing medium according to the embodiments of the invention will now be described with reference to the drawings. The image pickup apparatus of the embodiments is applied to an electronic camera.

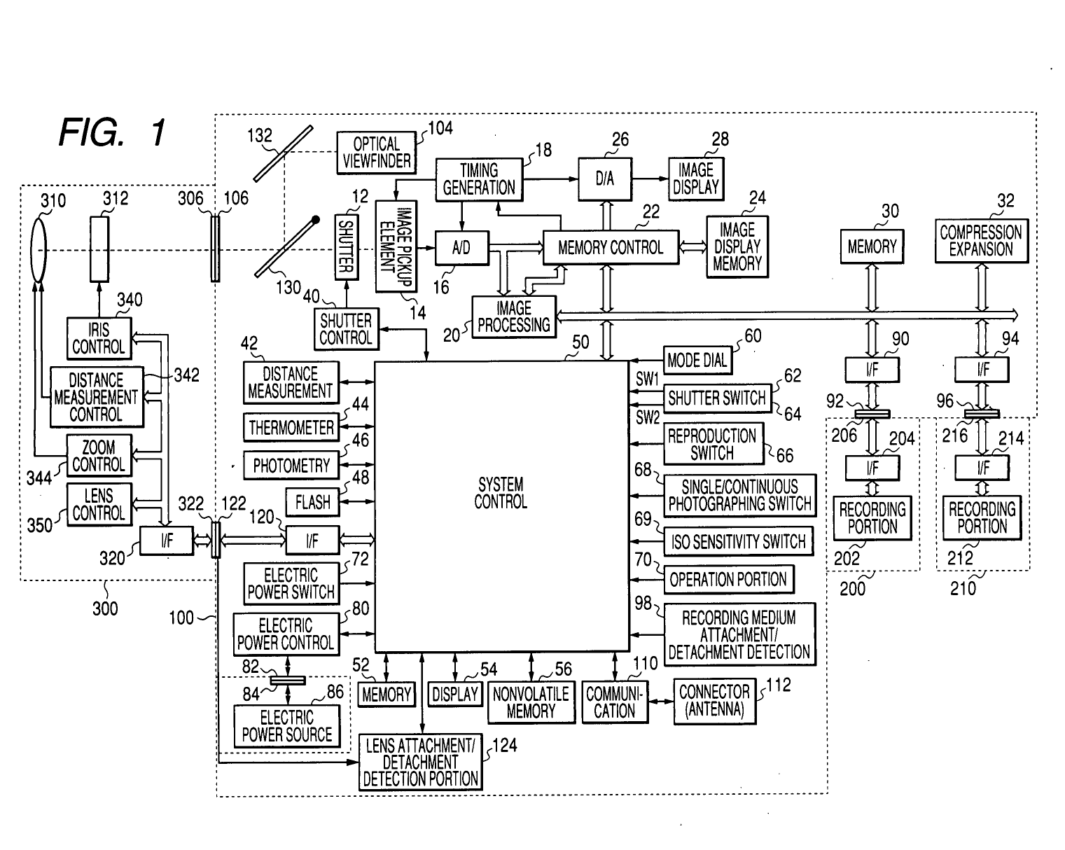

FIG. 1 is a block diagram showing a construction of the electronic camera in the embodiment. In FIG. 1, reference numeral 100 denotes an image processing apparatus; 12 a shutter having an iris function for controlling an exposure amount of an image pickup element 14; and 14 the image pickup element for converting an optical image into an electric signal.

Light incident into a photographing lens 310 in a lens unit 300 is guided to the image pickup element 14 by a single-lens reflex system through an iris 312, lens mounts 306 and 106, a mirror 130, and the shutter 12 and formed as an optical image onto the image pickup element 14.

Reference numeral 16 denotes an A/D converter for converting an analog signal outputted from the image pickup element 14 into a digital signal. Reference numeral 18 denotes a timing generation circuit for supplying a clock signal and a control signal to the image pickup element 14, the A/D converter 16, and a D/A converter 26. The timing generation circuit 18 is controlled by a memory control circuit 22 and a system control circuit 50.

Reference numeral 20 denotes an image processing circuit on executing predetermined pixel interpolation processing and color conversion processing on data supplied from the A/D converter 16 or data supplied from the memory control circuit 22. The image processing circuit 20 also executes a predetermined arithmetic operation processing by using the image data of photographed images as necessary. On the basis of an obtained arithmetic operation result, the system control circuit 50 executes an AF (auto focus) processing, an AE (auto exposure) processing, and an EF (flash light adjustment) processing of a TTL (through-the-lens) system for controlling an exposure (shutter) control portion 40 and a distance measurement control portion 42. The image processing circuit 20 also executes a predetermined arithmetic operation processing by using the image data of the photographed images and executes an AWB (auto white balance) processing of the TTL system on the basis of an obtained arithmetic operation result.

In the embodiment, since the dedicated distance measurement control portion 42 and a dedicated photometry control portion 46 are provided, it is also possible to construct the apparatus in such a manner that the system control circuit 50 executes the AF (auto focus) processing, AE (auto exposure) processing, and EF (flash light adjustment) processing by using the distance measurement control portion 42 and photometry control portion 46 and does not execute the AF (auto focus) processing, AE (auto exposure) processing, or EF (flash light adjustment) processing using the image processing circuit 20.

It is also possible to construct the apparatus in such a manner that the system control circuit 50 executes the AF (auto focus) processing, AE (auto exposure) processing, and EF (flash light adjustment) processing by using the distance measurement control portion 42 and photometry control portion 46 and further executes the AF (auto focus) processing, AE (auto exposure) processing, and EF (flash light adjustment) processing by using the image processing circuit 20.

Reference numeral 22 denotes the memory control circuit for controlling the A/D converter 16, timing generation circuit 18, image processing circuit 20, an image display memory 24, the D/A converter 26, a memory 30, and a compression/expansion circuit 32.

The data from the A/D converter 16 is written into the image display memory 24 or the memory 30 through the image processing circuit 20 and the memory control circuit 22 or directly through the memory control circuit 22.

Reference numeral 24 denotes the image display memory; 26 the D/A converter; and 28 an image display portion comprising an LCD of a TFT system. The image data for display written in the image display memory 24 is displayed onto the image display portion 28 through the D/A converter 26. In the case of sequentially displaying the image data of the photographed images by the image display portion 28, a function of an electronic viewfinder can be realized. The image display portion 28 can arbitrarily make an ON/OFF control of the display in accordance with an instruction from the system control circuit 50. When the display is turned off, electric power consumption of the image processing apparatus 100 can be remarkably reduced.

Reference numeral 30 denotes the memory for storing photographed still images or motion images. The memory 30 has a memory capacity enough to store a predetermined number of still images and motion images of a predetermined time. Therefore, also in the case of the continuous photographing for continuously photographing a plurality of still images or panoramic photographing, a large quantity of images can be written into the memory 30 at a high speed. The memory 30 can be also used as a work area of the system control circuit 50.

Reference numeral 32 denotes the compression/expansion circuit for compressing and decompressing the image data by adaptive discrete cosine transformation (ADCT) or the like. The circuit 32 reads out the image stored in the memory 30, executes a compression processing or a decompression processing, and writes the processed data into the memory 30.

Reference numeral 40 denotes the shutter control portion for controlling the shutter 12 in association with an iris control portion 340 for controlling the iris 312 on the basis of photometry information from the photometry control portion 46. Reference numeral 42 denotes the distance measurement control portion for executing the AF (auto focus) processing. The light incident into the photographing lens 310 in the lens unit 300 is inputted through the iris 312, lens mounts 306 and 106, mirror 130, and a submirror for distance measurement (not shown) by the single-lens reflex system, thereby measuring an in-focus state of the image formed as an optical image.

Reference numeral 44 denotes a thermometer for detecting an ambient temperature in a photographing environment. When the thermometer exists in the image pickup element (sensor) 14, a dark current of the sensor can be more accurately presumed.

Reference numeral 46 denotes the photometry control portion for executing the AE (auto exposure) processing. The light incident into the photographing lens 310 in the lens unit 300 is inputted through the iris 312, lens mounts 306 and 106, mirror 130, and a submirror for photometry (not shown) by the single-lens reflex system, thereby measuring an exposing state of the image formed as an optical image. The photometry control portion 46 also has the EF (flash light adjustment) processing function by associating with a flash portion 48. Reference numeral 48 denotes the flash portion having a light projecting function of AF auxiliary light and a flash light adjusting function.

As mentioned above, on the basis of the arithmetic operation result obtained by the image processing circuit 20 by using the image data of the images picked up by the image pickup element 14, the system control circuit 50 can make exposure control and AF (auto focus) control using the video TTL system to the exposure (shutter) control portion 40, the iris control portion 340, and a distance measurement control portion 342.

The AF (auto focus) control can be also made by using the measurement result by the distance measurement control portion 42 and the arithmetic operation result obtained by arithmetically operating the image data of the images picked up by the image pickup element 14 by the image processing circuit 20. Further, the exposure control can be also made by using the measurement result by the photometry control portion 46 and the arithmetic operation result obtained by arithmetically operating the image data of the images picked up by the image pickup element 14 by the image processing circuit 20.

Reference numeral 50 denotes the system control circuit for controlling the whole image processing apparatus 100. The circuit 50 has therein a well-known CPU and the like. Reference numeral 52 denotes a memory for storing constants, variables, programs, and the like for the operation of the system control circuit 50 and 54 indicates a display portion having a liquid crystal display (LCD) apparatus, a speaker, and the like for displaying an operating mode, a message, and the like with characters, an image, an audio sound, and the like in accordance with execution of the program in the system control circuit 50. The display portion(s) 54 is (are) disposed in one or a plurality of positions near an operation portion where the operators can easily observe the display contents. The display portion 54 is constructed by a combination of an LCD, an LED (light emitting diode), a sound generating device, and the like. A part of the functions of the display portion 54 is provided in an optical viewfinder 104.

Of the display contents of the display portion 54, the following contents are displayed by the LCD or the like: a single-shot/continuous photographing display; a self timer display; a compression ratio display; a display of the number of recording pixels; a display of the number of recorded pictures; a display of the number of residual pictures which can be photographed; a shutter speed display; an iris value display; an exposure correction display; a flash display; a red-eye relieving display; a macro photographing display; a buzzer setting display; a display of a residual capacity of a battery for timer; a display of a residual capacity of a battery; an error display; an information display by numerals of a plurality of digits; a display of an attachment/detachment state of recording media 200 and 210; a display of an attachment/detachment state of the lens unit 300; a display of a communication I/F operation; a display of time and date; a display showing a state of connection with an external computer; and the like.

Of the display contents of the display portion 54, the following contents are displayed by the optical viewfinder 104: an in-focus display; a photographing preparation completion display; a camera-shake warning display; a flash charging display; a flash-charge completion display; a shutter speed display; an iris value display; an exposure correction display; a display of a recording medium writing operation; and the like.

Of the display contents of the display portion 54, the following contents are displayed by the LED or the like: for example; an in-focus display; a photographing preparation completion display; a camera-shake warning display; a flash charging display; a flash-charge completion display; a display of a recording medium writing operation; a display of a macro photographing setting notification; a secondary battery charging display; and the like.

Of the display contents of the display portion 54, the following contents are displayed by a lamp or the like: for example; a self timer notification lamp and the like. The self timer notification lamp can be also used in common with the AF assistant light.

Reference numeral 56 denotes an electrically erasable and recordable nonvolatile memory in which programs, which will be explained hereinafter, and the like have been stored. An EEPROM or the like is used as a nonvolatile memory. Setting values such as various parameters, ISO sensitivity, and the like, setting modes, and the like are stored in the nonvolatile memory 56.

Reference numerals 60, 62, 64, 66, 68, and 70 denote operation portions for inputting various operating instructions of the system control circuit 50. The operation portions are constructed by one or a combination of a plurality of switches, a dial, a touch panel, a pointing device according to view-point detection, a voice recognizing apparatus, and the like. Details of those operation portions are shown below.

Reference numeral 60 denotes a mode dial switch which can switch and set each of the following function photographing modes: an auto photographing mode; a program photographing mode; a shutter speed preferential photographing mode; an iris preferential photographing mode; a manual photographing mode; a focal depth preferential (depth) photographing mode; a portrait photographing mode; a landscape photographing mode; a close-up photographing mode; a sports photographing mode; a night scene photographing mode; a panoramic photographing mode; and the like.

Reference numeral 62 denotes a shutter switch (SW1). The shutter switch 62 is turned on during the operation of a shutter button (not shown) and instructs the start of the operation such as AF (auto focus) processing, AE (auto exposure) processing, AWB (auto white balance) processing, EF (flash light adjustment) processing, and the like.

Reference numeral 64 denotes a shutter switch (SW2). The shutter switch 64 is turned on after completion of the operation of the shutter button (not shown). The shutter switch (SW2) 64 instructs the start of the operation of the following series of processings: an exposure processing for writing the image data of the signal read out from the image pickup element 14 into the memory 30 through the A/D converter 16 and the memory control circuit 22; a development processing using the arithmetic operations in the image processing circuit 20 and the memory control circuit 22; and a recording processing for reading out the image data from the memory 30, executing the compression in the compression/expansion circuit 32, and writing the image data into the recording media 200 and 210.

Reference numeral 66 denotes a reproduction switch for instructing the start of the reproducing operation for reading out images photographed in a photographing mode from the memory 30 or the recording medium 200 or 210 and displaying them onto the image display portion 28.

Reference numeral 68 denotes a single/continuous photographing switch. By the switch 68, it is possible to set a single photographing mode for photographing a single frame and setting the apparatus into a standby mode when the shutter switch SW2 is dedepressed or a continuous photographing mode for continuously executing the photographing while the shutter switch SW2 is dedepressed.

Reference numeral 69 denotes an ISO sensitivity setting switch. By the switch 69, it is possible to set an ISO sensitivity by changing the setting of a gain in the image pickup element 14 or the image processing circuit 20.

Reference numeral 70 denotes an operation portion comprising various buttons, a touch panel, and the like. There are the following buttons, switches, and the like: a menu button; a setting button; a macro button; a multiscreen reproduction new page button; a flash setting button; a single/continuous photographing/self timer switching button; a menu movement+(plus) button; a menu movement−(minus) button; a reproduction image movement+(plus) button; a reproduction image movement−(minus) button; a photographing picture quality selecting button; an exposure correcting button; a time/date setting button; a selecting/switching button for setting selection and switching of various functions when the photographing and reproduction of a panoramic mode or the like are executed; a deciding/executing button for setting the decision and execution of the various functions when the photographing and reproduction of a panoramic mode or the like are executed; an image display ON/OFF switch for setting ON/OFF of the image display portion 28; a quick review ON/OFF switch for setting a quick review function for automatically reproducing the image data of the photographed images just after the photographing; a compressing mode switch as a switch for selecting a compression ratio of the JPEG compression or selecting a CCDRAW mode for converting the signal from the image pickup element into the digital signal as it is and recording it onto a recording medium; a reproducing switch which can set each of function modes such as reproducing mode, a multiscreen reproducing/erasing mode, a PC connecting mode, and the like; an AF mode setting switch which can set a one-shot AF mode in which when the shutter switch SW1 is depressed, the auto focusing operation is started and, when an in-focus state is once obtained, the in-focus state is kept thereafter and a servo AF mode in which while the shutter switch SW1 is depressed, the auto focusing operation is continuously executed; and the like.

As to each function of the plus button and the minus button, by providing a rotary dial switch, the user can more easily select desired numerical value and function.

Reference numeral 72 denotes an electric power switch which can switch each mode of power-on and power-off of the image processing apparatus 100. Settings of power-on or power-off of various attachments such as lens unit 300, external strobe, recording media 200 and 210, and the like connected to the image processing apparatus 100 can be also switched.

Reference numeral 80 denotes an electric power control portion constructed by a battery detection circuit, a DC/DC converter, a switching circuit for switching blocks to be energized, and the like. The electric power control portion 80 discriminates whether a battery has been attached or not, detects a kind of battery and a residual capacity of the battery, controls the DC/DC converter on the basis of detection results and an instruction from the system control circuit 50, and supplies necessary voltages to each portion including the recording media for a necessary period of time.

Reference numeral 82 and 84 denote connectors and 86 indicates an electric power source comprising a primary battery such as alkali battery, lithium battery, or the like, a secondary battery such as NiCd battery, NiMH battery, Li battery, or the like, an AC adapter, and the like.

Reference numeral 90 and 94 denote interfaces with recording media such as memory card, hard disk, and the like; 92 and 96 connectors for connecting with the recording media such as memory card, hard disk, and the like; and 98 a recording medium attachment/detachment detection portion for detecting whether the recording media 200 and 210 are attached to the connectors 92 and 96 or not.

Although two systems of the interfaces and connectors for attaching the recording media are equipped in the embodiment, a single or an arbitrary number of systems of the interfaces and connectors for attaching the recording media can be equipped. As interfaces and connectors of different standards, interfaces and connectors which conform with the standards of a PCMCIA card, a CF (compact flash (registered trademark)) card, or the like can be also used.

Further, in the case of constructing the apparatus by using the interfaces and connectors which conform with the standards of the PCMCIA card, the CF (compact flash (registered trademark)) card, or the like as interfaces 90 and 94 and connectors 92 and 96, by connecting with various communication cards such as LAN card, modem card, USB card, IEEE1394 card, P1284 card, SCSI card, PHS, and the like, the image data and management information annexed to the image data can be mutually transferred to other computers or peripheral equipment such as a printer and the like.

Reference numeral 104 denotes the optical viewfinder by which the light incident into the photographing lens 310 can be guided through the iris 312, lens mounts 306 and 106, and mirrors 130 and 132 by the single-lens reflex system, formed as an optical image, and displayed. Thus, the photographing can be executed by using only the optical viewfinder 104 without using an electronic finder function according to the image display portion 28. Parts of the functions of the display portions 54, for example, the in-focus display, camera-shake warning display, the flash charging display, the shutter speed display, the iris value display, the exposure correction display, and the like are provided in the optical viewfinder 104.

Reference numeral 110 denotes a communication portion having various communicating functions such as RS232C, USB, IEEE1394, P1284, SCSI, modem, LAN, wireless communication, and the like, and 112 indicates a connector for connecting the image processing apparatus 100 to another apparatus by the communication portion 110 or an antenna which is used in the case of performing the wireless communication.

Reference numeral 120 denotes an interface for connecting the image processing apparatus 100 to the lens unit 300 in the lens mount 106; 122 a connector for electrically connecting the image processing apparatus 100 to the lens unit 300; and 124 a lens attachment/detachment detection portion for detecting whether the lens unit 300 is attached to the lens mount 106 and/or the connector 122 or not.

The connector 122 has functions for transmitting and receiving a control signal, a status signal, a data signal, and the like between the image processing apparatus 100 and the lens unit 300 and supplying currents of various voltages. The connector 122 can be also constructed so as to transmit not only an electric signal but also a photosignal, an audio signal, and the like.

Reference numerals 130 and 132 denote the mirrors for guiding the light incident into the photographing lens 310 to the optical viewfinder 104 by single-lens reflex system. The mirror 132 may have a construction of either a quick return mirror or a half mirror.

Reference numeral 200 denotes the recording medium such as memory card, hard disk, or the like. The recording medium 200 includes: a recording portion 202 constructed by a semiconductor memory, a magnetic disk, or the like; an interface 204 with the image processing apparatus 100; and a connector 206 for connecting to the image processing apparatus 100. Reference numeral 210 denotes the recording medium such as memory card, hard disk, or the like in a manner similar to the recording medium 200. The recording medium 210 includes: a recording portion 212 constructed by a semiconductor memory, a magnetic disk, or the like; an interface 214 with the image processing apparatus 100; and a connector 216 for connecting to the image processing apparatus 100.

Reference numeral 300 denotes the lens unit of an exchangeable lens type and 306 indicates the lens mount for mechanically coupling the lens unit 300 with the image processing apparatus 100. Various functions for electrically connecting the lens unit 300 to the image processing apparatus 100 are included in the lens mount 306.

Reference numeral 310 denotes the photographing lens; 312 the iris; 320 an interface for connecting the lens unit 300 to the image processing apparatus 100 in the lens mount 306; and 322 a connector for electrically connecting the lens unit 300 to the image processing apparatus 100.

The connector 322 has functions for transmitting and receiving the control signal, the status signal, the data signal, and the like between the image processing apparatus 100 and the lens unit 300, being supplied with various currents, or supplying various currents. The connector 322 may be also constructed so as to transmit not only the electric signal but also photosignal, audio signal, and the like.

Reference numeral 340 denotes the iris control portion for controlling the iris 312 on the basis of photometry information from the photometry control portion 46 in association with the shutter control portion 40 for controlling the shutter 12; 342 the distance measurement control portion for controlling the focusing of the photographing lens 310; 344 a zoom control portion for controlling the zooming of the photographing lens 310; and 350 a lens system control circuit for controlling the whole lens unit 300. The lens system control circuit 350 also has: a function of a memory for storing constants, variables, programs, and the like for operation; and a function of a nonvolatile memory for holding identification information such as a number peculiar to the lens unit 300, management information, function information such as opening iris value, minimum aperture value, focal distance, and the like, present and past setting values, and the like.

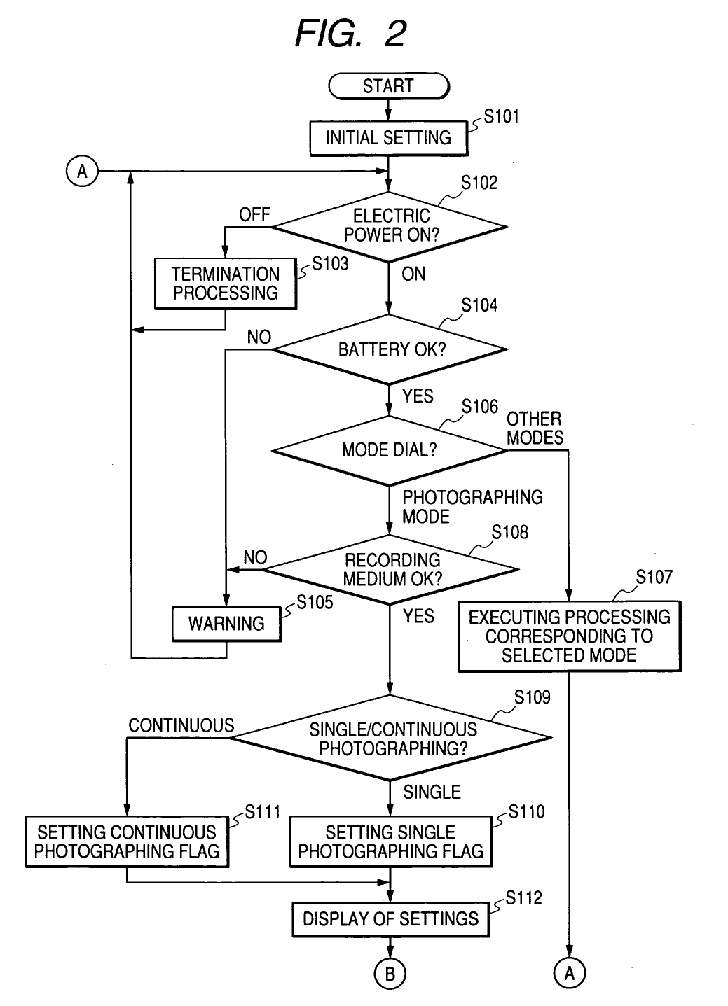

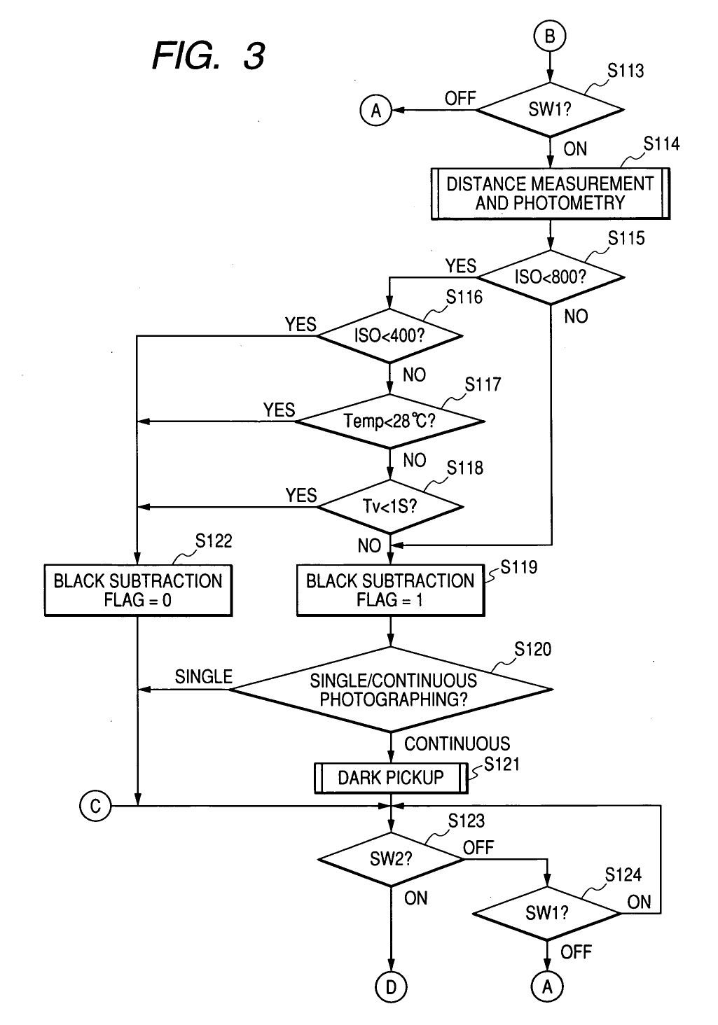

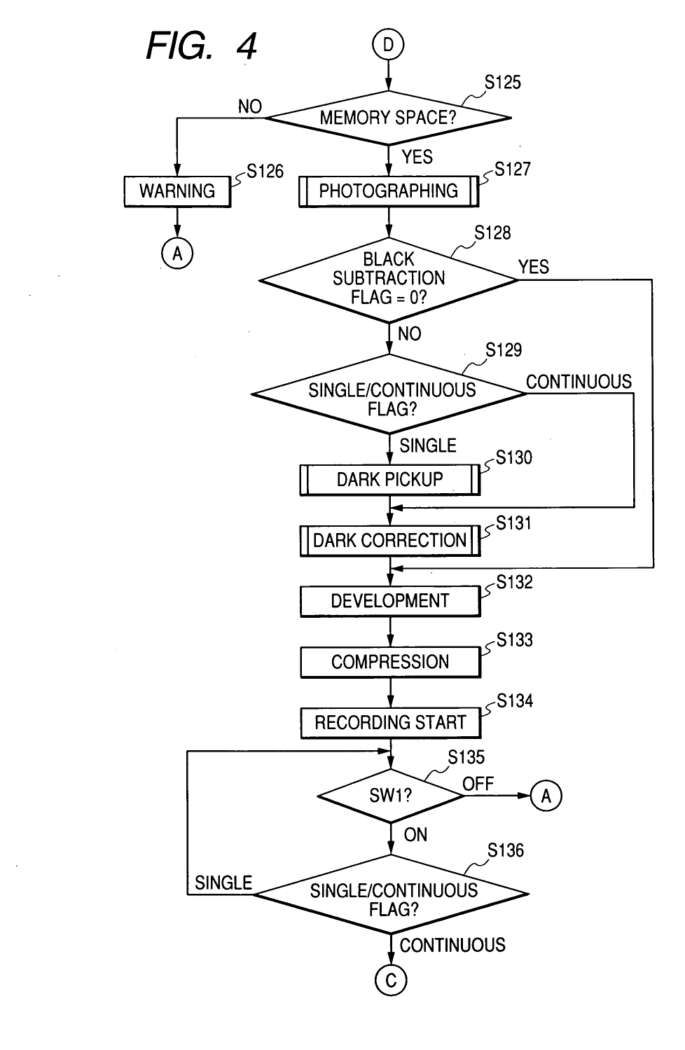

The operation of an electronic camera having the above construction will now be described. FIGS. 2, 3, and 4 are flowcharts showing the photographing operation processing procedure of the image processing apparatus 100. This processing program has been stored in the storing medium such as a nonvolatile memory 56 or the like. The processing program is loaded into the memory 52 and executed by a CPU in the system control circuit 50.

By turning on a power source by a battery exchange or the like, the system control circuit 50 initializes flags, control variables, and the like and executes a necessary predetermined initial setup to each portion of the image processing apparatus 100 (step S101). The system control circuit 50 detects a setting position of the electric power switch 72 and discriminates whether the electric power switch 72 has been turned off or not (step S102).

If the electric power switch 72 has been turned off, the display of each display portion is changed to an END status. Necessary parameters including the flags, control variables, and the like, setting values, and the setting mode are stored into the nonvolatile memory 56. A predetermined terminating processing such that an unnecessary power source of each portion of the image processing apparatus 100 including the image display portion 28 is shut off by the electric power control portion 80 or the like, is executed (step S103). After that, the processing routine is returned to a processing of step S102.

If the electric power switch 72 has been turned on, the system control circuit 50 causes the electric power control portion 80 to discriminate whether or not the residual capacity or the operating situation of the electric power source 86 such as a battery effects the operation of the image processing apparatus 100 (step S104). If it is determined that the affection is caused, a predetermined warning is performed to the display portion 54 by displaying an alarm image or generating an alarm sound (step S105). After that, the processing routine is returned to the processing of step S102.

If it is determined that there is no problem in the electric power source 86, the system control circuit 50 detects the setting position of the mode dial switch 60 and discriminates whether the mode dial switch 60 is set to the photographing mode or not (step S106). If the mode dial switch 60 is set to another mode, the system control circuit 50 executes the processings according to the selected state (step S107). After the execution, the processing routine is returned to the processing of step S102.

If the mode dial switch 60 is set to the photographing mode, it is discriminated whether the recording media 200 and 210 have been attached or not is discriminated, the management information of the image data recorded in the recording media 200 and 210 is obtained, and whether or not the operating modes of the recording media 200 and 210 effects the operation of the image processing apparatus 100, particularly, the recording and reproducing operations of the image data to/from the recording media (step S108). If it is determined that the affection exists, a predetermined warning is performed to the display portion 54 by displaying an alarm image or generating an alarm sound (step S105). After that, the processing routine is returned to the processing of step S102.

If it is determined in step S108 that there is no problem, the system control circuit 50 discriminates a selecting state of the single/continuous photographing switch 68 for selecting the single/continuous photographing (step S109). If the single photographing is selected, a single/continuous photographing flag is set to the single photographing (step S110). If the continuous photographing is selected, the single/continuous photographing flag is set to the continuous photographing (step S11). In the single/continuous photographing switch 68, when the shutter switch SW2 is depressed, it is possible to arbitrarily switch and set the single photographing mode for photographing a signal frame and setting the apparatus into the standby mode and the continuous photographing mode for continuously executing the photographing while the shutter switch SW2 is depressed. The status of the single/continuous photographing flag is stored into an internal memory of the system control circuit 50 or the memory 52.

The system control circuit 50 displays the various setting status of the image processing apparatus 100 by an image or a sound by using the display portion 54 (step 112). When the image display switch of the image display portion 28 is ON, the various setting status of the image processing apparatus 100 may be also displayed by an image or a sound by using the image display portion 28.

Whether the shutter switch SW1 is depressed or not is discriminated (step S113). If the shutter switch SW1 is not depressed, the processing routine is returned to the processing of step S102. If the shutter switch SW1 is depressed, the system control circuit 50 executes distance measurement/photometry processings in which a focal point of the photographing lens 310 is set to the object by executing the distance measurement processing and an iris value and a shutter speed are determined by executing the photometry processing (step S114). In the photometry processing, a flash is set as necessary. Details of the distance measurement/photometry processings will be described hereinafter.

After that, the set sensitivity of the camera is discriminated. That is, whether or not the sensitivity set by the ISO sensitivity setting switch 69 is less than ISO800 is discriminated (step S115). This is because when the sensitivity is less than ISO800, since the exposure amount is small, the deterioration in picture quality due to the pixel loss or the like caused by the dark current noises which are generated in the image pickup element or the micro defects which are peculiar to the image pickup element becomes conspicuous. Although the sensitivity is set to ISO800 in the embodiment, naturally, it may be also set to ISO600. When it is equal to or larger than ISO800, the processing routine advances to a processing of step S119. When it is less than ISO800, whether or not the set sensitivity is less than ISO400 is further discriminated (step S116).

When it is less than ISO400, the processing routine advances to the processing of step S122. When it is equal to or larger than ISO400, whether or not an ambient temperature Temp which is measured by the thermometer 44 is less than 28° C. is discriminated (step S117) . When it is less than 28° C., the processing routine advances to a processing of step S122. When it is equal to or larger than 28° C., whether or not shutter time Tv is less than 1 second is discriminated (step S118). When it is less than 1 second, the processing routine advances to the processing of step S122. When it is equal to or larger than 1 second, the processing routine advances to a processing of step S119.

Although ISO400, 28° C., and one second are set as threshold values in the condition discrimination in steps S116 to S118, they may be also set to other proper values in accordance with the characteristics of image pickup element 14, respectively.

Since the dark current noise increases with the charge accumulation time or the increase in temperature of the image pickup element, in the case of executing the exposure for a long seconds of time or at a high temperature, it is necessary to perform the correction by black subtraction. Therefore, when all conditions in steps S116 to S118 are not satisfied, a black subtraction flag is set to a value “1” (step S119). A set status of the single/continuous photographing flag is checked (step S120). If the single photographing is set, since the dark pickup is performed after completion of the main photographing, the processing routine advances to a processing of step S123 as it is. If the continuous photographing is set, after the dark pickup for black subtraction is performed (photographing in the non-exposing state) (step S121), the processing routine advances to the processing of step S123. By executing the correction arithmetic operation processing by using the dark image data picked up by the dark pickup processing, the photographed image data can be corrected against the deterioration in picture quality caused by the pixel loss or the like due to the dark current noises which are generated in the image pickup element 14 or the defects which are peculiar to the image pickup element 14. The dark pickup processing will be described hereinafter.

If some of the conditions are satisfied in the processings in steps S116 to S118, since the black subtraction is not performed, the black subtraction flag is cleared to the value “0” (step S122). The processing routine advances to the processing of step S123. The status of the black subtraction flag is stored into the internal memory of the system control circuit 50 or the memory 52.

Whether or not the shutter switch SW2 is depressed is discriminated (step S123). If the shutter switch SW2 is not depressed, whether or not the shutter switch SW1 is released is discriminated (step S124). The processings of steps S123 and S124 are repeated until the shutter switch SW1 is released or the shutter switch SW2 is depressed. When the shutter switch SW1 is released in step S124, The processing routine advances to the processing of step S102.

When the shutter switch SW2 is depressed in step S123, the system control circuit 50 discriminates whether or not an image storing buffer area which can store the photographed image data exists in the memory 30 (step S125). If it is determined that the area which can store the new image data does not exist in the image storing buffer area in the memory 30, a predetermined warning is performed to the display portion 54 by displaying an alarm image or generating an alarm sound (step S126). After that, the processing routine is returned to the processing of step S102.

For example, such a situation corresponds to the case just after the maximum number of pictures which can be stored into the image storing buffer area in the memory 30 were continuously photographed, and the apparatus is in the state where the first image to be read out from the memory 30 and written into the recording media 200 and 210 is not recorded yet into the recording media 200 and 210 and the state where a space area of one picture cannot be held on the image storing buffer area in the memory 30, or the like.

In the case where the photographed image data is compressed and thereafter stored into the image storing buffer area in the memory 30, whether or not the area where the image data can be stored exists in the image storing buffer area in the memory 30 is discriminated by the processing in step S125 in consideration of a point that the image data amount after the compression differs in accordance with the setting of the compressing mode.

If it is determined in step S125 that the image storing buffer area where the photographed image data can be stored exists in the memory 30, the system control circuit 50 executes a photographing processing (photographing in the exposing state) in which the image pickup signal accumulated for a predetermined time is read out from the image pickup element 14 and the photographed image data is written into the predetermined area in the memory 30 through the A/D converter 16, the image processing circuit 20, and the memory control circuit 22 or directly from the A/D converter 16 through the memory control circuit 22 (step S127). Details of the photographing processing will be explained hereinafter.

After the photographing processing of step S127 is completed, the system control circuit 50 confirms the status of the black subtraction flag stored in its internal memory or in the memory 52 (step S128). When the black subtraction flag is not set to the value “1”, the processing routine advances to a processing of step S132. When the black subtraction flag is set to the value “1”, the system control circuit 50 discriminates the status of the single/continuous photographing flag which is stored in its internal memory or in the memory 52 (step S129). If the continuous photographing is set, the processing routine advances to a processing of step S131.

As mentioned above, if the continuous photographing is set in step S129, since the dark pickup processing has already been executed prior to executing the continuous photographing in step S121, the dark pickup processing of step S130 is not executed but the dark correction processing is executed (step S131) and subsequently, a development processing is executed (step S132), thereby substantially equalizing intervals of the continuously photographed frames.

If the single photographing is set in step S129, the system control circuit 50 executes the dark pickup processing in which the noise components such as a dark current or the like of the image pickup element 14 are accumulated for the same time as that of the main photographing in the state where the shutter 12 is closed (non-exposing state) and the noise image signal after the accumulation is read out (step S130). The processing. routine advances to the processing of step S131.

Step S131 is the dark correction processing for eliminating the dark current noises or the like of the image pickup element 14 by executing the subtraction processing by using the dark image data picked up in the dark pickup processing.

In the case of executing a correction arithmetic operation processing by using the dark image data picked up in the dark pickup processing, the photographed image data can be corrected against the picture quality deterioration having two-dimensional factors such as a pixel loss or the like due to the defects which are peculiar to the image pickup element 14 as well as the dark current noises which are generated in the image pickup element 14 and the fixed pattern noises.

The system control circuit 50 executes a WB (white balance) integration arithmetic operation processing and an OB (optical black) integration arithmetic operation processing which are necessary for reading out a part of the image data written in the predetermined area in the memory 30 through the memory control circuit 22 and executing the development processing, and stores arithmetic operation results into the internal memory of the system control circuit 50 or into the memory 52.

The system control circuit 50 reads out the photographed image data written in the predetermined area in the memory 30, by using the memory control circuit 22 and, if necessary, the image processing circuit 20 and executes various development processings including a defect correction processing, an AWB (auto white balance) processing, a gamma conversion processing, and a color conversion processing by using the arithmetic operation results stored in the internal memory of the system control circuit 50 or in the memory 52 (step S132).

The system control circuit 50 reads out the image data written in the predetermined area in the memory 30, executes the image compression processing according to the set mode by the compression/expansion circuit 32, and writes the photographed image data after completion of the series of processings into the space image portion in the image storing buffer area in the memory 30 (step S133).

The system control circuit 50 reads out the image data stored in the image storing buffer area in the memory 30 and starts a recording processing for writing the read-out image data into the recording media 200 and 210 such as memory card, compact flash (registered trademark) card, or the like through the interfaces 90 and 94 and the connectors 92 and 96 (step S134). The recording start processing is executed to the image data each time the photographed image data after completion of the series of processings is newly written into the space image portion in the image storing buffer area in the memory 30.

While the image data is written into the recording media 200 and 210, in order to show that the writing operation is being executed, the recording medium writing operation is displayed to the display portion 54 by, for example, a method of flickering the LED, or the like.

Further, the system control circuit 50 discriminates whether or not the shutter switch SW1 is depressed (step S135). If the shutter switch SW1 is in the released state, the processing routine is returned to the processing of step S102. If the shutter switch SW1 is in the depressed state, the status of the single/continuous photographing flag stored in the internal memory of the system control circuit 50 or in the memory 52 is discriminated (step S136). If the single photographing is set, the processing routine is returned to the processing of step S135 and the present processings are repeated until the shutter switch SW1 is released. If the continuous photographing is set, in order to continuously photograph, the processing routine is returned to the processing of step S123, thereby preparing for the next photographing. Thus, the series of processings regarding the photographing is completed.

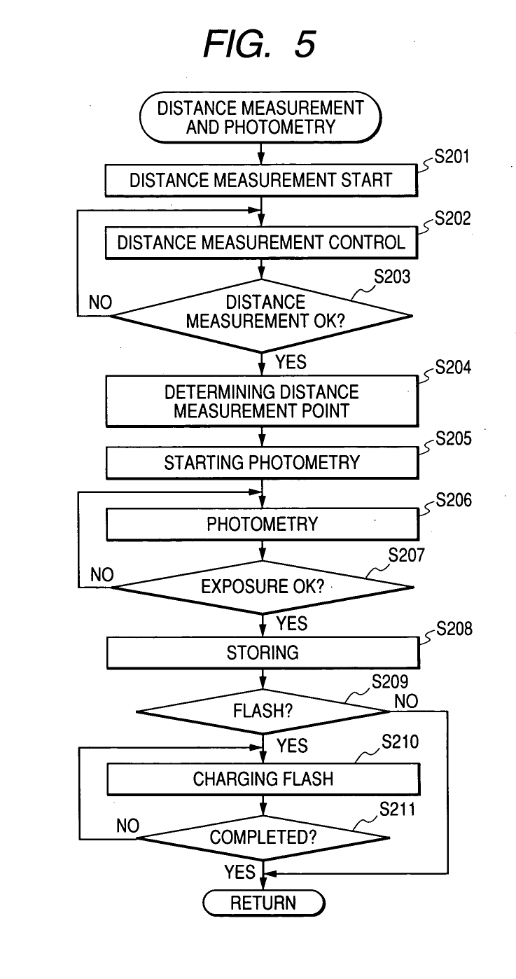

FIG. 5 is a flowchart showing a distance measurement/photometry processing procedure in step S114. In the distance measurement/photometry processing, transmission and reception of various signals between the system control circuit 50 and the iris control portion 340 or the distance measurement control portion 342 are executed through the interface 120, the connectors 122 and 322, the interface 320, and the lens system control circuit 350.

The system control circuit 50 starts the AF (auto focus) processing by using the image pickup element 14, the distance measurement control portion 42, and the distance measurement control portion 342 (step S201).

The system control circuit 50 discriminates the in-focus state of the image formed as an optical image by inputting the light incident into the photographing lens 310 into the distance measurement control portion 42 through the iris 312, lens mounts 306 and 106, mirror 130, and submirror for distance measurement (not shown) and executes the AF control for detecting the in-focus state by using the distance measurement control portion 42 while driving the photographing lens 310 by using the distance measurement control portion 342 until it is determined that the distance measurement (AF) indicates the in-focus state (steps S202, S203).

If it is determined in step S203 that the distance measurement (AF) indicates the in-focus state, the system control circuit 50 decides an in-focus distance measurement point from a plurality of distance measurement points in the photographing display screen and stores distance measurement data and/or setting parameters into the internal memory of the system control circuit 50 or in the memory 52 together with the decided distance measurement point data (step S204).

Subsequently, the system control circuit 50 starts the AE (auto exposure) processing by using the photometry control portion 46 (step S205). The system control circuit 50 measures the exposing state of the image formed as an optical image by inputting the light incident into the photographing lens 310 into the photometry control portion 46 through the iris 312, lens mounts 306 and 106, mirrors 130 and 132, and a lens for photometry (not shown) and executes the photometry processing by using the exposure (shutter) control portion 40 until it is determined that the exposure (AE) is correct (steps S206, S207).

If it is determined in step S207 that the exposure (AE) is appropriate, the system control circuit 50 stores the photometry data and/or the setting parameters into the internal memory of the system control circuit 50 or in the memory 52 (step S208).

In the system control circuit 50, the iris value (Av value) and the shutter speed (Tv value) are determined in accordance with the exposure (AE) result detected by the photometry processing in step S206 and the photographing mode set by the mode dial switch 60.

The system control circuit 50 determines the charge accumulation time of the image pickup element 14 in accordance with the decided shutter speed (Tv value), executes the photographing processing for the decided charge accumulation time, and executes the dark pickup processing according to the charge accumulation time.

The system control circuit 50 discriminates the necessity of the flash on the basis of the measurement data obtained by the photometry processing in step S206 (step S209). If the flash is necessary, a flash flag is set and the flash portion 48 is charged until the charging is completed (steps S210, S211). After completion of the charging of the flash portion 48, the processing routine is finished and returned to the main processing routine.

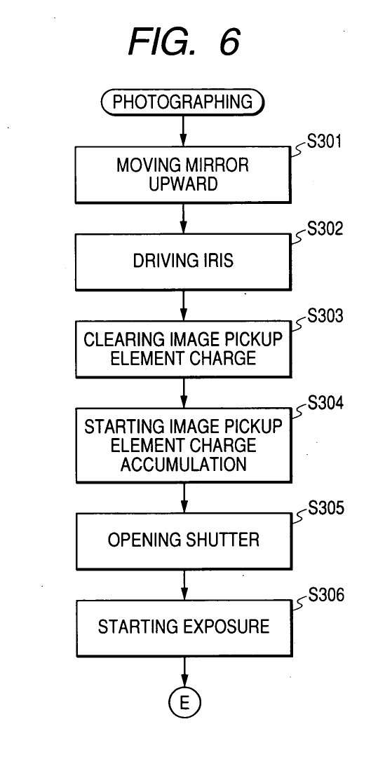

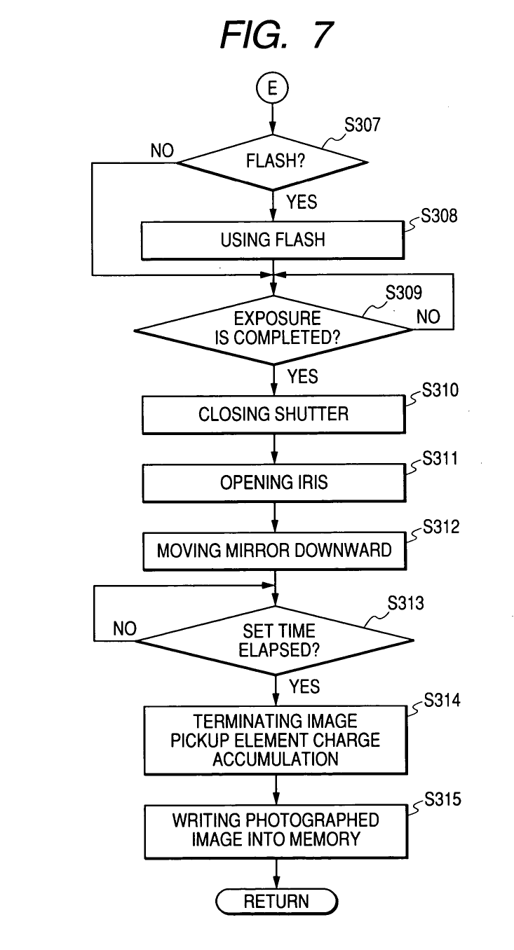

FIGS. 6 and 7 are flowcharts showing a photographing processing procedure in step S127. In this photographing processing, transmission and reception of various signals between the system control circuit 50 and the iris control portion 340 or the distance measurement control portion 342 are executed through the interface 120, the connectors 122 and 322, the interface 320, and the lens system control circuit 350.

The system control circuit 50 moves the mirror 130 to a mirror upward position by a mirror driving portion (not shown) (step S301) and drives the iris 312 to a predetermined iris value by the iris control portion 340 in accordance with the photometry data stored in the internal memory of the system control circuit 50 or in the memory 52 (step S302).

After the system control circuit 50 executed the charge clearing operation of the image pickup element 14 (step S303), it starts the charge accumulation of the image pickup element 14 (step S304), opens the shutter 12 by the shutter control portion 40 (step S305), and starts the exposure of the image pickup element 14 (step S306).

The necessity of the flash portion 48 is discriminated by the flash flag (step S307). If it is necessary, the flash portion 48 is made operative (step S308).

The system control circuit 50 waits for the completion of the exposure of the image pickup element 14 in accordance with the photometry data (step S309). When the exposure is completed, the shutter 12 is closed by the shutter control portion 40 (step S310) and the exposure of the image pickup element 14 is completed.

The system control circuit 50 drives the iris 312 to the opening iris value by the iris control portion 340 (step S311) and moves the mirror 130 to a mirror downward position by the mirror driving portion (not shown) (step S312).

Whether the set charge accumulation time has elapsed or not is discriminated (step S313). If the set charge accumulation time has elapsed, the system control circuit 50 finishes the charge accumulation of the image pickup element 14 (step S314), thereafter, reads out the charge signal from the image pickup element 14, and writes the photographed image data into the predetermined area in the memory 30 through the A/D converter 16, the image processing circuit 20, and the memory control circuit 22 or directly from the A/D converter 16 through the memory control circuit 22 (step S315). When the series of processings is completed, the processing routine is finished and returned to the main processing routine.

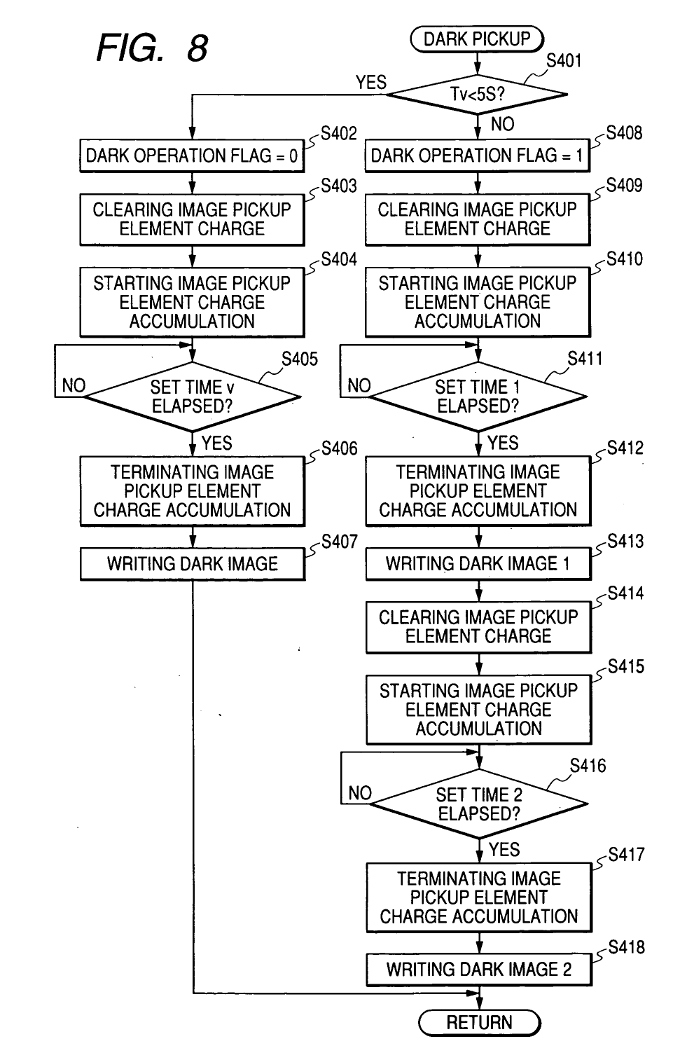

FIG. 8 is a flowchart showing a dark pickup processing procedure in steps S121 and S130. The dark pickup processing is executed in the state where the shutter 12 is closed, that is, in the state where the image pickup element 14 is shielded against the light.

The system control circuit 50 discriminates whether the shutter time (exposure time) Tv is less than 5 seconds or not (step S401). If it is less than 5 seconds, the processing routine advances to a processing in step S402. If it is equal to or larger than 5 seconds, the processing routine advances to a processing in step S408.

Although the value of 5 seconds is set as a threshold value in the conditional discrimination in step S402, naturally, it may be set to another proper value.

When the shutter time Tv is less than 5 seconds, a dark operation flag is cleared to a value “0” in order to execute the dark image photographing for the same accumulation time as that of the main photographed image without executing the arithmetic operation of the dark image data (step S402) and the dark image photographing is executed. A status of the dark operation flag is stored into the internal memory of the system control circuit 50 or in the memory 52.

The system control circuit 50 executes the charge clearing operation of the image pickup element 14 (step S403), thereafter, starts the charge accumulation of the image pickup element 14 (step S404), and discriminates whether the set charge accumulation time Tv has elapsed or not (step S405). If the set charge accumulation time has elapsed, the system control circuit 50 reads out the charge signal from the image pickup element 14 after completion of the charge accumulation of the image pickup element 14 (step S406) and writes the dark image data into the predetermined area in the memory 30 through the A/D converter 16, the image processing circuit 20, and the memory control circuit 22 or directly from the A/D converter 16 through the memory control circuit 22 (step S407). After that, the processing routine is finished and returned to the main processing routine.

When the shutter time Tv is equal to or larger than 5 seconds, the dark operation flag is set to a value “1” in order to execute the arithmetic operation of the dark image data (step S408) and the dark image photographing is executed twice for the different accumulation time.

The accumulation times of two times are assumed to be set time 1 and set time 2 respectively. Those two time values are set to, for example, 0.5 second and 1 second which are shorter than the accumulation time of the main image.

The system control circuit 50 executes the charge clearing operation of the image pickup element 14 (step S409), thereafter, starts the charge accumulation of the image pickup element 14 (step S410), and discriminates whether the set charge accumulation time (set time 1) has elapsed or not (step S411). If the set charge accumulation time has elapsed, the system control circuit 50 reads out the charge signal from the image pickup element 14 after completion of the charge accumulation of the image pickup element 14 (step S412) and writes the dark image data 1 into the predetermined area in the memory 30 through the A/D converter 16, the image processing circuit 20, and the memory control circuit 22 or directly from the A/D converter 16 through the memory control circuit 22 (step S413).

After that, the dark image photographing of the second time is executed. In a manner similar to the first time, the system control circuit 50 executes the charge clearing operation of the image pickup element 14 (step S414), thereafter, starts the charge accumulation of the image pickup element 14 (step S415), and discriminates whether the set charge accumulation time (set time 2) has elapsed or not (step S416). If the set charge accumulation time has elapsed, the system control circuit 50 reads out the charge signal from the image pickup element 14 after completion of the charge accumulation of the image pickup element 14 (step S417) and writes the dark image data 2 into the predetermined area in the memory 30 through the A/D converter 16, the image processing circuit 20, and the memory control circuit 22 or directly from the A/D converter 16 through the memory control circuit 22 (step S418). After that, the processing routine is finished and returned to the main processing routine.

The dark image data photographed by the dark pickup processing (steps S121 and S130) is used in the dark correction processing (step S131).

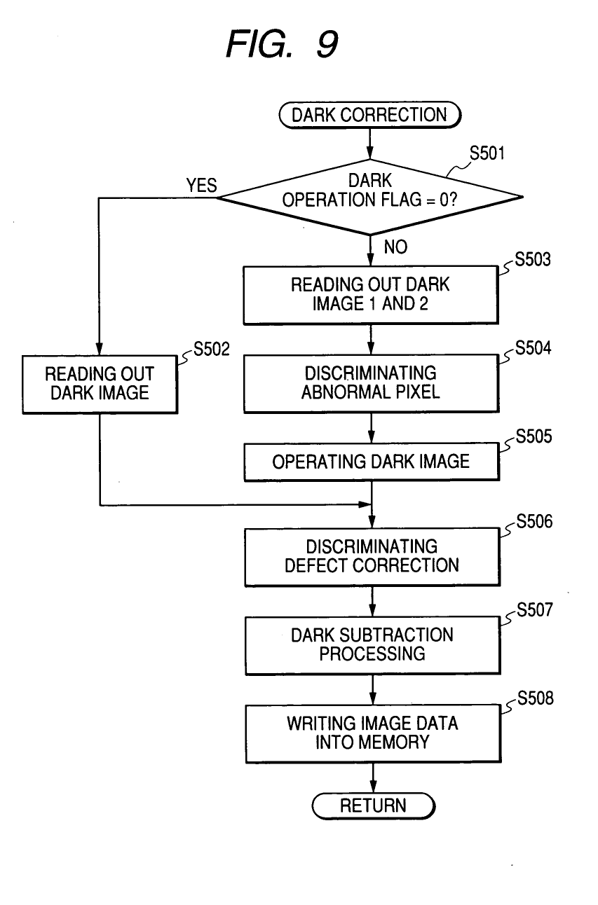

FIG. 9 is a flowchart showing the dark correction processing procedure in step S131.

The system control circuit 50 discriminates a status of a dark operation flag (step S501). If it is cleared to the value “0”, the dark image data written in the predetermined area in the memory 30 is read out (step S502). The processing routine advances to a processing of step S506.

When dark operation flag is set to the value “1”, the processing routine advances to a processing of step S503.

The system control circuit 50 reads out the two dark image data (dark image data 1, dark image data 2) written in the predetermined area in the memory 30 (step S503) and makes an abnormal pixel discrimination for detecting an abnormal pixel on the basis of the two dark image data (step S504). Upon discrimination of the abnormal pixel, in each dark image or either of the dark images, when a difference between a data value of the target pixel and an average data value of its peripheral pixels is larger than a preset value, it is determined that the target pixel is abnormal. A ratio of the data values of the target pixels in the two dark images and a ratio of the accumulation time of the two dark images are compared. When they are larger than preset values, it is determined that the target pixel is abnormal. The pixel determined to be abnormal in step S504 is set to a target of the defect correction which is made in the development processing (step S132) and its pixel position is stored into the internal memory of the system control circuit 50 or in the memory 52. That is, the image data of the abnormal pixel is interpolated on the basis of the peripheral pixels of the detected abnormal pixel in the main photographed image data.

After that, the system control circuit 50 executes a processing for arithmetically operating the dark image data of the same accumulation time as that in the main photographing from the two dark image data of different accumulation time (step S505).

The pixel in which the dark data value of each pixel is equal to or larger than a preset threshold value will become a factor which suppresses a dynamic range of the pixel. Therefore, such a pixel is determined to be a defect (step S506). To make the defect correction in the development processing (step S132) by using the dark image data of the same accumulation time as that in the main photographing image which was actually photographed or the calculated dark image data, its pixel position is stored into the internal memory of the system control circuit 50 or in the memory 52.

After that, a subtraction processing between the main photographing image data and the dark image data is executed (step S507) and a result is written as image data into the predetermined area in the memory 30 (step S508). After that, the processing routine is finished and returned to the main processing routine.

A dark image arithmetic operation processing (step S505) will now be described.

The main photographing image data is assumed to be GS, the dark image data 1 is assumed to be D1, and the dark image data 2 is assumed to be D2. The accumulation time at the time of photographing the main photographing image data is assumed to be TS, the accumulation time at the time of photographing the dark image data 1 is assumed to be T1, and the accumulation time at the time of photographing the dark image data 2 is assumed to be T2. In the present embodiment, there is a relation of TS>T2>T1 among the accumulation time. In this conditions, by arithmetically operating the two dark image data D1 and D2 every pixel, dark image data D of the same accumulation time as that upon main image photographing is calculated.

For the dark image data D, when a component which depends on the accumulation time of the dark current or the like is assumed to be Da and a component which does not depend on the accumulation time such as circuit noises or the like is assumed to be Db, the components Da and Db are expressed by the following equations.

$$\begin{matrix}Da = \frac{D2 - D1}{T2 - T1} \\ Db = D1 - Da \times T1 \\ = D2 - Da \times T2 \\ = \frac{D1 \times T2 - D2 \times T1}{T2 - T1}\end{matrix}$$

Therefore, the dark image data D is calculated from the two dark image data of the different accumulation time.

$$\begin{matrix}D = Da \times Ts + Db \\ = \frac{D2 - D1}{T2 - T1} \times Ts + \frac{D1 \times T2 - D2 \times T1}{T2 - T1} \\ = \frac{D2 \times ( Ts - T1 ) - D1 \times ( Ts - T2 )}{T2 - T1}\end{matrix}$$

As mentioned above, in the image pickup apparatus of the embodiment, by controlling the execution of the dark correction processing according to the charge accumulation time, that is, the shutter time of the camera and the sensitivity setting of the camera or the ambient temperature and by using the two dark images of the different seconds of time shorter than the accumulation time of the main image photographing, there is no need to photograph the dark image data of the accumulation time of the main image photographing. Therefore, the shutter release time lag can be reduced and such a problem that the photographer misses a shutter chance due to the shutter release time lag is eliminated.

With respect to the abnormality which cannot be perfectly corrected by the dark correction processing, by detecting its pixel position and executing the defect correction processing for interpolating the abnormal pixel by using its peripheral pixels, the deterioration in picture quality can be prevented.

Although the embodiments of the invention have been described above, the present invention is not limited to the constructions of the embodiments but can be applied to any other constructions which can accomplish the functions shown in the scope of Claims or the functions of the constructions of the embodiments.

For example, although the dark image data of the same accumulation time as that in the main image photographing is calculated from the two dark image data in the foregoing embodiments, it is also possible to construct in such a manner that the dark image data of the same accumulation time as that in the photographing of a plurality of main images is calculated by using three or more dark image data and an average of them is obtained every pixel and used as dark image data which is used in the dark subtraction processing.

The embodiment is featured by: the means for photographing at least two kinds of dark images of different accumulation time shorter than the accumulation time of the main photographing for photographing the object image in the state where the image pickup element is not exposed and extracting the noise component which depends on the accumulation time from the plurality of dark image data; and the means for extracting the noise component which does not depend on the accumulation time. The embodiment is also featured by: the means for calculating the dark image data having the noise component of the same accumulation time as that upon main photographing from the noise component which depends on the accumulation time and the noise component irrespective of the accumulation time; and the means for correcting the main photographing image data by using the calculated dark image data. Further, the embodiment is featured by: the means for detecting the abnormal pixel based on the plurality of dark image data and the calculated dark image data and, in the case of the abnormal pixel, executing the interpolation processing using the peripheral pixels.

According to the embodiment, since there is no need to photograph the dark image of the same accumulation time as that in the main image photographing, the shutter release time lag can be reduced and such a problem that the photographer misses a shutter chance due to the shutter release time lag is eliminated.

By controlling the dark correction processing on the basis of the photographing conditions such as ISO sensitivity and shutter seconds of time or the environmental conditions such as an ambient temperature and the like, under the photographing conditions in which there is a possibility of deterioration in image, the processing for preventing such deterioration is executed and the image of high picture quality can be photographed.

As mentioned above, while reducing the photographing of the dark image which becomes a cause of the shutter release time lag to the minimum, the deterioration in picture quality can be prevented.

The embodiment can be realized by executing the program by the computer. Means for supplying the program to the computer, for example, the computer-readable recording medium such as a CD-ROM or the like in which such a program has been recorded or the transmitting medium such as Internet or the like for transmitting such a program can be also applied as an embodiment of the invention. A computer program product such as a computer-readable recording medium or the like in which such a program has been recorded can be also applied as an embodiment of the invention. The above program, recording medium, transmitting medium, and computer program product are incorporated in the purview of the invention. As a recording medium, for example, a flexible disk, a hard disk, an optical disk, a magnetooptic disk, a CD-ROM, a magnetic tape, a nonvolatile memory card, a ROM, or the like can be used.

The above embodiments are merely shown as specific examples upon embodying the invention and a technical scope of the invention must not be limitedly interpreted by them. That is, the invention can be embodied by various forms without departing from its technical idea or its principal features.

The present invention is not limited to the above embodiments and various changes and modifications can be made within the spirit and scope of the present invention. Therefore, to apprise the public of the scope of the present invention, the following claims are made.

1. An image pickup apparatus comprising:
an image pickup unit for obtaining image data by picking up a plurality of images of different charge accumulation time in a non-exposing state and obtaining image data by picking up images in an exposing state; and
a correcting unit for correcting the image data of the images picked up in said exposing state on the basis of the image data of said plurality of images picked up in said non-exposing state,
wherein the charge accumulation time for the image data of said plurality of images picked up in said non-exposing state is shorter than that of the image data of the images picked up in said exposing state.

2. An apparatus according to claim 1, wherein said correcting unit is arranged so that when a shutter time of the image data of the images which are picked up in said exposing state is equal to or larger than a predetermined value, said a correcting unit corrects the image data of the images picked up in said exposing state on the basis of the image data of said plurality of images picked up in said non-exposing state, and when the shutter time of the image data of the images which are picked up in said exposing state is less than said predetermined value, said correcting unit corrects the image data of the images picked up in the exposing. state on the basis of the image data of one image obtained by picking up it in the non-exposing state.

3. An apparatus according to claim 1, further comprising:
an abnormal pixel correcting unit for detecting an abnormal pixel on the basis of the image data of said plurality of images picked up in said non-exposing state; and
an abnormal pixel a correcting unit for correcting the image data of said detected abnormal pixel among the image data of the images picked up in said exposing state.

4. An apparatus according to claim 1, wherein said correcting unit corrects the image data on the basis of a photographing condition in said exposing state.

5. An apparatus according to claim 4, wherein said photographing condition is ISO sensitivity.

6. An apparatus according to claim 5, wherein said correcting unit is arranged so that when said ISO sensitivity is equal to or larger than a predetermined value, said a correcting unit corrects the image data of the images picked up in said exposing state on the basis of the image data of said plurality of images picked up in said non-exposing state, and when said ISO sensitivity is less than said predetermined value, said a correcting unit does not correct the image data.

7. An apparatus according to claim 1, wherein said correcting unit corrects the image data on the basis of an environmental condition.

8. An apparatus according to claim 7, wherein said environmental condition is a temperature.

9. An apparatus according to claim 8, wherein said correcting unit is arranged so that when said temperature is equal to or larger than a predetermined value, said a correcting unit corrects the image data of the images picked up in said exposing state on the basis of the image data of said plurality of images picked up in said non-exposing state, and when said temperature is less than said predetermined value, said a correcting unit does not correct the image data.

10. An apparatus according to claim 1, wherein:
said correcting unit is arranged to correct the image data when an ISO sensitivity in the photographing in said exposing state is equal to or larger than a predetermined value and a shutter time is equal to or larger than a predetermined value and a temperature is equal to or larger than a predetermined value.

11. An image pickup method comprising:
an image pickup step of obtaining image data by picking up a plurality of images of different charge accumulation time in a non-exposing state and obtaining image data by picking up images in an exposing state; and
a correcting step of correcting the image data of the images picked up in said exposing state on the basis of the image data of said plurality of images picked up in said non-exposing state,
wherein the charge accumulation time for the image data of said plurality of images picked up in said non-exposing state is shorter than that of the image data of the images picked up in said exposing state.
